(19) United States
(12) Patent Application Publication
(10) Pub. No.: US 2010/0081379 A1
(43) Pub. Date: Apr. 1, 2010

(54) WIRELESSLY POWERED SPEAKER

(75) Inventors: Emily B. COOPER, Seattle, WA (US); Joshua R. SMITH, Seattle, WA (US); Alanson P. SAMPLE, Seattle, WA (US)

Correspondence Address: Pillsbury Winthrop Shaw Pittman LLP;(INTEL), P.O. Box 10500, McLean, VA, 22102, US

(73) Assignee: INTEL CORPORATION, Santa Clara, CA (US)

(21) Appl. No.: 12/567,651

(22) Filed: Sep. 25, 2009

Related U.S. Application Data
(63) Continuation-in-part of application No. 12/544,974, filed on Aug. 20, 2009.
(60) Provisional application No. 61/189,502, filed on Aug. 20, 2008.

(51) Int. Cl. H04B 5/00

(52) U.S. Cl. 455/41.1

(57) ABSTRACT

In accordance with various aspects of the disclosure, a method and apparatus is disclosed that includes features of wirelessly powering a speaker. A system of coupled magnetic resonators may be used to deliver both power and audio wirelessly to a receiver/radio receiver/speaker.

### CROSS REFERENCE TO RELATED APPLICATIONS

This application is a Continuation-in-part application (CIP) of U.S. patent application Ser. No. 12/544,974 filed on Aug. 20, 2009 which claims benefit under 35 U.S.C. §119(e) from U.S. Provisional Application No. 61/189,502 filed on Aug. 20, 2008, both of which are incorporated herein by reference in their entirety.

### BACKGROUND

This disclosure relates generally to the field of power transmission, and in particular, to a method and apparatus for transmitting and receiving power and/or audio wirelessly.

Wireless power transfer has the potential to transform electronics by “cutting the last cord,” freeing users from the need to plug in to recharge devices, and changing the design space, for example by enabling devices with no connectors.

Coupled resonator wireless power transfer is capable of delivering power with more efficiency than far field approaches and at longer range than traditional inductive schemes. However, conventional coupled resonator systems have been limited to operation at a particular fixed distance and orientation, with efficiency falling rapidly as the receiver moves away from the optimal operating point. Moreover, conventional coupled resonator systems use bulky, non-flat resonator structures.

Ordinary speakers are powered via a wired connection to a power and audio source (e.g., a stereo amplifier, which gets power from a wired connection to a grid). Existing wireless speakers receive data via wireless communication signals (e.g., radio, WiFi, and/or other signals), but get their power from on-board batteries, which must be recharged by a wired connection (or replaced with charged batteries).

Speaker elements typically require audio signals (e.g., 20 Hz-20 kHz) with power levels of milliwatts to hundreds of watts. Wireless communication signals (e.g., radio, WiFi, and/or other signals) are typically microwatts or less at the receiver. Radio receivers, for example, receive a small audio signal (i.e., audio signal with low power level) from a remote location. The received audio signal is amplified with on-board electronics, which may ultimately be powered by a source local to the receiver.

A crystal radio is an example of a radio receiver device that does not use amplification and therefore does not require a power supply. However, the lack of amplification makes a crystal radio receiver suitable only for listening with headphones and impractical for loudspeaker actuation. In a crystal radio receiver, audio signals are transmitted over long distances, but only a small quantity of power is received. Extending the concept of the crystal radio receiver to a transmission system capable of power levels suitable for loudspeaker actuation would require unsafe and infeasible power transmission levels. Additionally, the use of ordinary radio propagation would result in highly inefficient operation, since the high power levels would (typically) be transmitted in all directions, effectively wasting large amounts of power.

Methods exist for powering devices wirelessly using a “power surface,” “pad,” or “mat”. While such solutions do eliminate batteries and a wired connection, they would require the user to place the speaker/radio receiver directly proximal to the surface. In some solutions, a specific orientation with respect to the power pad is required. The power transfer efficiency of these methods decreases dramatically with distance between the source (surface) and receiver (speaker), such that appreciable power cannot be transferred beyond a source receiver distance greater than a few millimeters.

### BRIEF DESCRIPTION OF THE DRAWINGS

FIG. 1a shows an exemplary system diagram of an auto-tuning wireless power transfer system in accordance with various aspects of the present disclosure.

FIG. 1b shows an equivalent circuit diagram for the exemplary system of FIG. 1a in accordance with various aspects of the present disclosure.

FIG. 1c shows a photograph of an experimental set-up of a Tx Loop and Tx Coil (left), and Rx Coil and Rx Loop (right) in accordance with various aspects of the present disclosure.

FIG. 2a shows a plot of |S₂₁| as a function of frequency and Tx-Rx coupling (k₂₃) in accordance with various aspects of the present disclosure.

FIG. 2b shows a plot of |S₂₁| as a function of k₂₃ and k₁₂ in accordance with various aspects of the present disclosure.

FIG. 3a shows a locally fit model comparing experimental data (black dots) to the elementary transfer function (dotted line), and to the complete transfer function (line), for the best fit value of k₂₃ in accordance with various aspects of the present disclosure.

FIG. 3b shows a locally fit model comparing experimental S21 magnitude data (black dots) and analytical model (surface) computed from the complete transfer function, both plotted versus frequency and Tx-Rx distance in accordance with various aspects of the present disclosure.

FIG. 4a shows a model (lines) compared to experimental data (black circles), with k₂₃ values calculated from geometry (not fit to data) where |S₂₁| is plotted vs distance in accordance with various aspects of the present disclosure.

FIG. 4b shows the model of FIG. 4a where resonant peak locations are plotted as a function of distance in accordance with various aspects of the present disclosure.

FIG. 4c shows the model of FIG. 4a where resonant peak magnitudes are plotted as a function of distance in accordance with various aspects of the present invention.

FIG. 5 shows efficiency-range tradeoff: |S₂₁|_{Critical} vs. k_{Critical} tradeoff curve as a function of the tuning parameter k_{Ic}, with our system's operating point indicated (large dot at k_{Ic}=0.135) in accordance with various aspects of the present invention.

FIG. 6a shows an experimental implementation where tuning frequency compensates for range changes in accordance with various aspects of the present invention.

FIG. 6b shows the experimental implementation of FIG. 6a where tuning frequency compensates for orientation changes in accordance with various aspects of the present invention.

FIG. 6c shows the experimental implementation of FIG. 6a where a laptop computer is powered wirelessly in accordance with various aspects of the present invention.

FIG. 7 shows a representative top view of the experimental implementation of FIG. 6a illustrating the varying orientation of the receiver (Rx Coil and Rx Loop) in accordance with various aspects of the present invention.

FIG. 8 shows a plot of range (critical coupling distance) vs. Rx radius, for Tx radius=0.15 m.

FIG. 9 shows an exemplary functional block diagram for wirelessly powering a speaker in accordance with various aspects of the present disclosure.

FIG. 10 shows an exemplary implementation of a system for wirelessly powering a speaker in accordance with various aspects of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, an apparatus is disclosed that includes a transmitter comprising a modulation circuit configured to modulate a power carrier signal with an audio signal to form a modulated signal; and a resonator configured to couple with a resonator of a receiver, wherein the resonator is configured to transmit the modulated signal wirelessly to the resonator of the receiver.

In accordance with various embodiments of this disclosure, an apparatus is disclosed that includes a receiver comprising a resonator configured to: couple with a resonator of a transmitter; and receive a modulated signal wirelessly from the transmitter, wherein the modulated signal comprises a power carrier signal modulated with an audio signal.

In accordance with various embodiments of this disclosure, a method is disclosed that includes coupling a resonator of a transmitter and a resonator of a receiver; modulating a power carrier signal with an audio signal to form a modulated signal; and transmitting the modulated signal wirelessly from the resonator of the transmitter to the resonator of the receiver.

In accordance with various embodiments of this disclosure, a method is disclosed that includes coupling a resonator of a receiver and a resonator of a transmitter; and receiving a modulated signal wirelessly from the transmitter, wherein the modulated signal comprises a power carrier signal modulated with an audio signal.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

Turning now to the various aspects of the disclosure, a model is disclosed of coupled resonators in terms of passive circuit elements. The conventional analysis, based on coupled mode theory, is difficult to apply to practical systems in terms of quantities such as inductance (L), capacitance (C), and resistance (R) that are measurable in the laboratory at high frequencies (HF band) that is herein disclosed. The disclosed model shows that to maintain efficient power transfer, system parameters must be tuned to compensate for variations in Transmit-to-Receive (“Tx-Rx”) range and orientation.

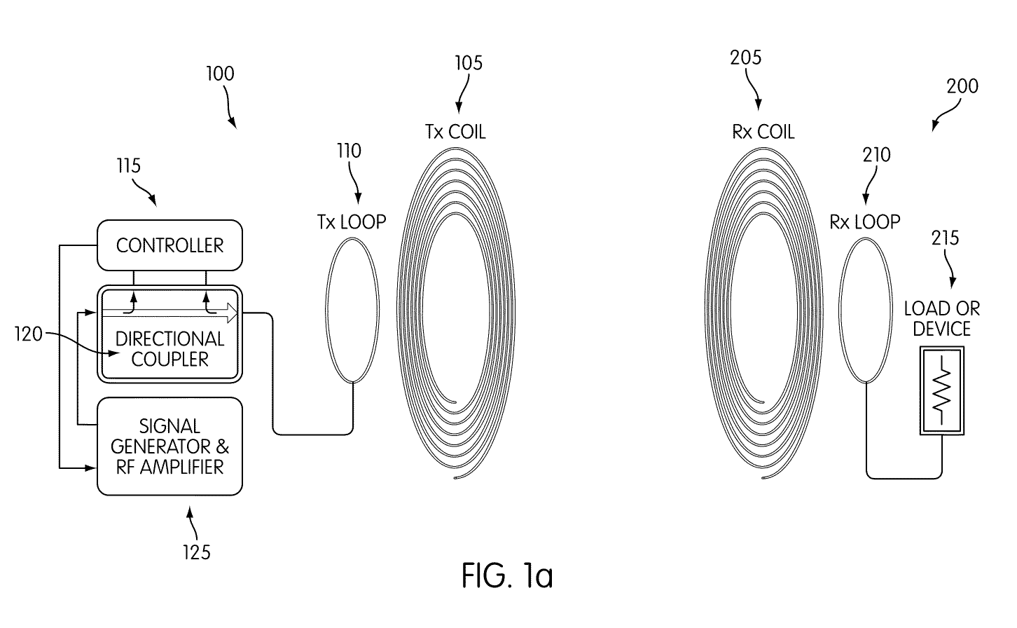

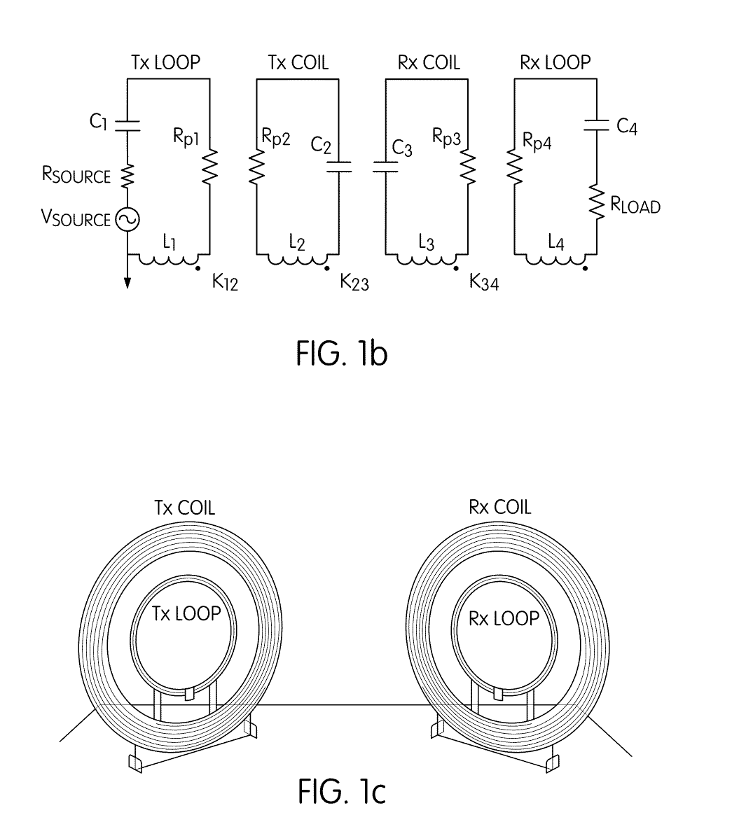

FIG. 1a shows an exemplary system diagram of an auto-tuning wireless power transfer system in accordance with various aspects of the present disclosure. FIG. 1b shows an equivalent circuit diagram including four coupled resonant circuits for the exemplary system of FIG. 1a. FIG. 1c shows a photograph of an experimental set-up of a wireless power transfer apparatus including a Tx Loop and Tx Coil (left), and Rx Coil and Rx Loop (right).

Turning to FIG. 1a, one aspect of the present disclosure is shown. A transmitter 100 is configured to supply power wirelessly to a receiver 200. The transmitter 100 is shown having a transmitter resonator or resonator of the transmitter 105 as a coil (Tx Coil). Similarly, the receiver 200 is shown having a receiver resonator or resonator of the receiver 205 as a coil (Rx Coil). In some aspects, the transmitter resonator (Tx Coil) and/or the receiver resonator (Rx Coil) is a substantially two-dimensional structure. The transmitter resonator (Tx Coil) is coupled to a transmitter impedance-matching structure 110. Similarly, the receiver resonator (Rx Coil) is coupled to a receiver impedance-matching structure 210. As shown in FIG. 1a, the transmitter impedance-matching structure 110 is a loop (Tx Loop) and the receiver impedance-matching structure 210 is a loop (Rx Loop). Other impedance-matching structures may be used for the transmitter 100, the receiver 200, or both which include a transformer and/or and an impedance-matching network. The impedance-matching network may include inductors and capacitors configured to connect a signal source to the resonator structure.

Transmitter 100 includes a controller 115, a directional coupler 120 and a signal generator and radio frequency (RF) amplifier 125 which are configured to supply control power to a drive loop (Tx Loop). Impedance-matching structure 110 of the transmitter 100 such as drive loop or Tx Loop is configured to be excited by a source (not shown in FIG. 1a) with finite output impedance R_{source}. Signal generator 125 output is amplified and fed to the Tx Loop. Power is transferred magnetically from Tx Loop to Tx Coil to Rx Loop to Rx Coil, and delivered by ohmic connection to the load 215.

If the system becomes mis-tuned because of a change in Tx-Rx distance, a reflection may occur on the transmitter side. The directional coupler 120 separates the reflected power from the forward power, allowing these quantities to be measured separately. The controller 115 adjusts transmit frequency to minimize the ratio of reflected to forward power, thereby retuning the system for the new working distance.

Turning to FIG. 1b, a simple one-turn drive loop (Tx Loop) can be modeled as an inductor L₁ with parasitic resistance Rₚ₁. For element i, distributed inductance is labeled Lᵢ, distributed capacitance is Cᵢ, and parasitic resistance is Rₚᵢ. The coupling coefficient for the mutual inductance linking inductor i to inductor j is labeled kᵢⱼ. Capacitor may be added to make drive loop (Tx Loop) resonant at a frequency of interest, bringing the net capacitance for the loop to C₁. Drive loop (Tx Loop) is powered by source (V_{source}). Transmit coil (Tx Coil) may be a multi-turn air core spiral inductor L₂, with parasitic resistance Rₚ₂. Capacitance C₂ of transmit coil (Tx Coil) is defined by its geometry. Inductors L₁ and L₂ are connected with coupling coefficient k₁₂, where

$${k}_{ij} = \frac{{M}_{ij}}{\sqrt{{L}_{i} {L}_{j}}}$$

is the coupling coefficient linking inductors i and j, and Mᵢⱼ is the mutual inductance between i and j. Note that 0≦kᵢⱼ≦1. Coupling coefficient k₁₂ is determined by the geometry of drive loop (Tx Loop) and transmit coil (Tx Coil). Receiver apparatus is defined similarly to the transmitter apparatus: L₃ is the inductance of receiver coil (Rx Coil) and L₄ is the inductance of load loop (Rx Loop). Transmitter coil (Tx Coil) and receiver coil (Rx Coil) are linked by coupling coefficient k₂₃, which depends on both Tx-Rx range and relative orientation. Drive loop (Tx Loop) and load loop (Rx Loop) may be configured to impedance match source and load to high Q resonators (Tx Coil and Rx Coil).

As discussed above, source and load loops (Tx Loop and Rx Loop) may be replaced by other impedance matching components. The Tx loop (or equivalent component) and Tx coil may both be embedded in the same piece of equipment (and likewise for the Rx coil and Rx Loop or equivalent component). Thus, coupling constants k₁₂ and k₃₄ are variables that the can be, in principle, controlled, unlike coupling constant k₂₃, which is an uncontrolled environmental variable determined by usage conditions.

Uncontrolled environmental parameters may include parameters such as a range between the transmitter resonator (Tx Coil) and the receiver resonator (Rx Coil), a relative orientation between the transmitter resonator (Tx Coil) and the receiver resonator (Rx Coil), and a variable load on the receiver resonator (Rx Coil). By way of a non-limiting example, a variable load can be a device that experiences variations in a power state, such as a laptop computer powering on, down, or entering stand-by or hibernate mode. Other examples, may include a light bulb having various illumination states, such a dim or full brightness.

System parameters, such as the coupling constants k₁₂ and k₃₄, are variables that the can be, in principle, controlled and that we can be adjust to compensate for the changes in environmental parameters. Other such system parameters may include a frequency at which power is transmitted, an impedance of the transmitter resonator and an impedance of the receiver resonator.

Writing Kirchhoff's voltage law (KVL) for each of the sub-circuits in the FIG. 1b allows the current in each to be determine:

$${I}_{1} ( {R}_{Source} + {R}_{p 1} + jω {L}_{1} + \frac{1}{j ω {C}_{1}} ) + jω {I}_{2} {k}_{12} \sqrt{{L}_{1} {L}_{2}} = {V}_{S}$$

$${I}_{2} ( {R}_{p 2} + jω {L}_{2} + \frac{1}{jω {C}_{2}} ) + jω ( {I}_{1} {k}_{12} \sqrt{{L}_{1} {L}_{2}} - {I}_{3} {k}_{23} \sqrt{{L}_{2} {L}_{3}} ) = 0$$

$${I}_{3} ( {R}_{p 3} + jω {L}_{3} + \frac{1}{jω {C}_{3}} ) + jω ( {I}_{4} {k}_{34} \sqrt{{L}_{3} {L}_{4}} - {I}_{2} {k}_{23} \sqrt{{L}_{2} {L}_{3}} ) = 0$$

$${I}_{4} ( {R}_{Load} + {R}_{P 4} + jω {L}_{4} + \frac{1}{jω {C}_{4}} ) + jω {I}_{3} {k}_{34} \sqrt{{L}_{3} {L}_{4}} = 0$$

Solving these four KVL equations simultaneously for the voltage across the load resistor yields the transfer function for this system of coupled resonators:

$$\begin{matrix}{V}_{Gain} ≡ \frac{{V}_{Load}}{{V}_{Source}} \\ = \frac{{iω}^{3} {k}_{12} {k}_{23} {k}_{34} {L}_{2} {L}_{3} \sqrt{{L}_{1} {L}_{4}} {R}_{Load}}{{k}_{12}^{2} {k}_{34}^{2} {L}_{1} {L}_{2} {L}_{3} {L}_{4} {ω}^{4} + {Z}_{1} {Z}_{2} {Z}_{3} {Z}_{4} + {ω}^{2} ( \begin{matrix}{k}_{12}^{2} {L}_{1} {L}_{2} {Z}_{3} {Z}_{4} + \\ {k}_{23}^{2} {L}_{2} {L}_{3} {Z}_{1} {Z}_{4} + \\ {k}_{34}^{2} {L}_{3} {L}_{4} {Z}_{1} {Z}_{2}\end{matrix} )}\end{matrix} ( 1 )$$

where V_{Load} is the voltage across the load resistor and

Z₁=(Rₚ₁+R_{source}+iωL₁−i/(ωC₁)

Z₂=(Rₚ₂+iωL₂−i/(ωC₂)

Z₃=(Rₚ₃+iωL₃−i/(ωC₃)

Z₄=(Rₚ₄+R_{Load}+iωL₄−i/(ωC₄)

The analytical transfer function was cross-validated by comparing its predictions with SPICE (Simulation Program with Integrated Circuit Emphasis) simulations. As is known, SPICE is a general-purpose analog electronic circuit simulator that is used in integrated circuit (IC) and board-level design to check the integrity of circuit designs and to predict circuit behavior. From Eq. 1, a scattering parameter S₂₁ can be calculated and shown to be:

$${S}_{21} = 2 \frac{{V}_{Load}}{{V}_{Source}} {( \frac{{R}_{Source}}{{R}_{Load}} )}^{1 / 2} \qquad ( 2 )$$

which can be important experimentally since it can be measured with a vector network analyzer, which as known, is an instrument used to analyze the properties of electrical networks, especially those properties associated with the reflection and transmission of electrical signals known as scattering parameters (S-parameters). The entire wireless power transfer apparatus can be viewed as a two-port network (one port being the input, fed by source, and the other the output, feeding the load). In a two-port network, S₂₁ is a complex quantity representing the magnitude and phase of the ratio of the signal at the output port to the signal at the input port. Power gain, the essential measure of power transfer efficiency, is given by |S₂₁|², the squared magnitude of S₂₁. As presented below, experimental and theoretical results are presented in terms of |S₂₁|.

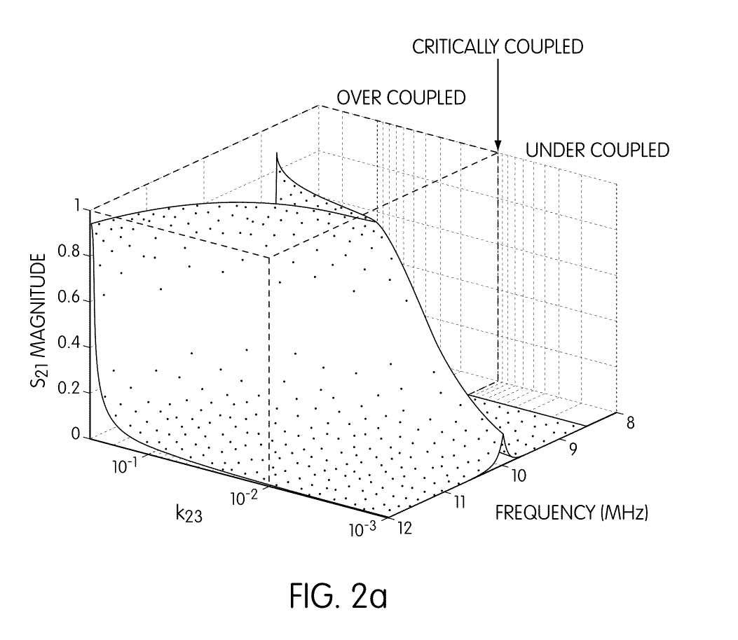

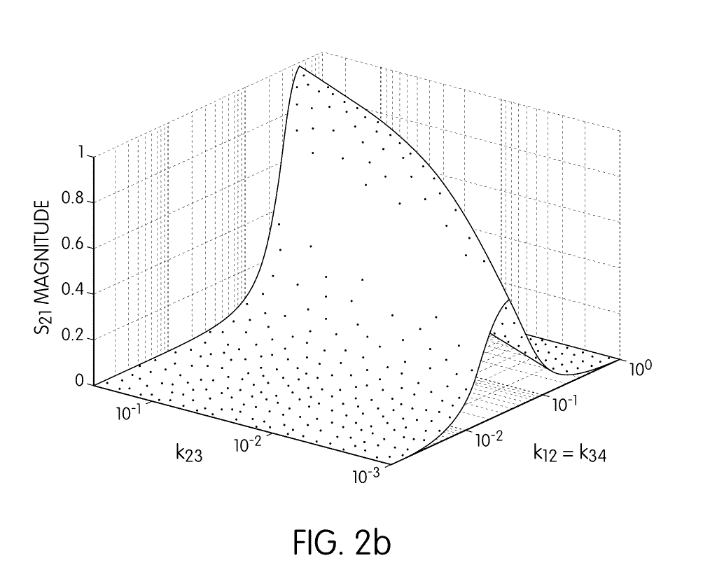

In FIG. 2a, |S₂₁| is plotted for a realistic set of parameters, as shown in Table S1 below, as a function of the Tx-Rx coupling constant k₂₃ and the driving angular frequency w. In this plot, k₁₂ and k₃₄ are held constant, which would typically be the case for a fixed antenna design. This elementary transfer function neglects parasitic coupling, such as that from the drive loop (Tx Loop) direct to the receiver coil (Rx Coil), i.e. the k₁₃ coupling. A more complete model that includes parasitic effects will be discussed later. However, the elementary model captures the essential behavior and is likely to be useful long term, as future systems may have reduced parasitic coupling.

FIG. 2a shows the dependence of system efficiency on frequency and k₂₃. On the k₂₃ axis, smaller values correspond to larger Tx-Rx distances because the mutual inductance between the transmitter coil (Tx Coil) and receiver coil (Rx Coil) decreases with distance. Changing the angle of the receiver coil (Rx Coil) with respect to the transmitter coil (Tx Coil) can also change k₂₃. For example, rotating an on-axis receiver coil (Rx Coil) from being parallel to the transmitter coil (Tx Coil) to being perpendicular would decrease their mutual inductance and therefore k₂₃. Moving the receiver coil (Rx Coil) in a direction perpendicular to the transmit axis would also typically change k₂₃.

FIG. 2a shows the plot partitioned into 3 regimes, corresponding to different values of k₂₃. In the overcoupled regime, represented in FIG. 2a as the dotted lines that enclose the V-shaped ridge, k₂₃>k_{Critical}. (The value of the constant k_{Critical} will be defined below in terms of the features of the surface plotted in the figure.) In the critically coupled regime, which is the plane bounding this volume, k₂₃=k_{Critical}. In the under-coupled regime beyond the volume outlined by the dotted lines, k₂₃<k_{Critical}.

High efficiency of power transmission occurs on the top of the V-shaped ridge. The V-shape is due to resonance splitting: in the over-coupled regime (i.e. for any choice of k₂₃>k_{Critical}) there are two frequencies at which maximum power transfer efficiency occurs. These correspond to the system's two normal modes. The more strongly coupled the resonators (transmitter coil (Tx Coil) and receiver coil (Rx Coil)) are, the greater the frequency splitting; the difference between the two normal mode frequencies increases with k₂₃. As k₂₃ decreases, the modes move closer together in frequency until they merge. The value of k₂₃ at which they merge (the point denoted by “I” on the V-shaped ridge) is defined to be the critical coupling point k_{Critical}. The frequency at which the modes merge is the single resonator natural frequency ω=ω₀ (assuming both coils have the same ω₀). Note that the mode amplitude is nearly constant throughout the over-coupled and critically coupled regime, allowing high efficiency; as k₂₃ drops below k_{Critical}, the single mode amplitude decreases, lowering the maximum system efficiency achievable.

Because of the nearly constant mode amplitude throughout the overcoupled regime, system efficiency could be kept nearly constant as k₂₃ varies (as long as k₂₃>k_{Critical}), if the system transmit frequency could be adjusted to keep the operating point on top of the ridge. In other words, as the Tx-Rx distance (and thus k₂₃) changes due to motion of the receiver, the system could be re-tuned for maximum efficiency by adjusting the frequency to keep the operating point on the top of the ridge.

As disclosed below, tuning transmitter resonator (Tx Coil) automatically to maximize transmission power can be achieved based on the results. Because the tuning compensates for changes in k₂₃, the same technique can compensate for any geometrical variation that changes k₂₃ (by a sufficiently small amount), including changes in orientation, and non-range changing translations.

A correctly functioning control system may allow the system efficiency to be nearly independent of range, for any range up to the critical range. It may be counter-intuitive that power transfer efficiency can be approximately independent of range (even within a bounded working region), since the power delivered by far-field propagation depends on range r as 1/r², and traditional non-adaptive inductive schemes have 1/r³ falloff. Therefore, the top of the efficiency ridge, along which the efficiency is approximately constant is referred to as the “magic regime” for wireless power transfer. The values of k₂₃ that the magic regime spans are given by k_{Critical}≦k₂₃≦1. Thus, the smaller k_{Critical}, the larger the spatial extent spanned by the magic regime, and thus the larger the system's effective working range.

In FIG. 2b, frequency is held constant while k₁₂ (and k₃₄, constrained for simplicity to equal k₁₂) is varied. Adapting k₁₂ to compensate for detuning caused by changes in k₂₃ is another method for adapting to varying range and orientation.

Further analysis of the transfer function (Eq. 1) gives insight into the effect of circuit parameters on the performance of the wireless power system. As explained above, the effective operating range is determined by the value of k_{Critical}: the smaller k_{Critical}, the greater the spatial extent of the magic regime.

So, to understand system range, it will be useful to solve for k_{Critical} in terms of design parameters. First, the transfer function can be clarified by substituting expressions for quality factor:

$${Q}_{i} = \frac{1}{{R}_{1}} \sqrt{\frac{{L}_{i}}{{C}_{i}}} = \frac{{ω}_{0}^{i} {L}_{i}}{{R}_{i}} = \frac{1}{{ω}_{0}^{i} {R}_{i} {C}_{i}} , where {ω}_{0}^{i} = \frac{1}{\sqrt{{L}_{i} {C}_{i}}}$$

is the uncoupled resonant frequency of element i.

For simplicity, consider a symmetrical system, with the quality factor of the Tx and Rx coils equal, Q_{Coil}=Q₂=Q₃, and the quality factors of the Tx and Rx loops equal, Q_{Loop}=Q₁=Q₄. The symmetric loop-to-coil coupling k₁₂=k₃₄ will be denoted k_{Ic}. Also it is assumed that R_{Source}=R_{Load}, Rₚ₁<R_{Source}, Rₚ₄<R_{Load}, and that the uncoupled resonant frequencies are equal: ω₀ⁱ=ω₀ for all i. To find an expression for the critical coupling value, consider the transfer function when the system is driven at frequency ω=ω₀. This corresponds to a 2D slice of FIG. 2a along the center frequency of 10 MHz, whose apex is the critical coupling point of the system. Using the expressions for ω in terms of Q above, this slice of the transfer function can be written

$${V}_{Gain \vert ω = {ω}_{0}} = \frac{i {k}_{23} {k}_{lc}^{2} {Q}_{Coil}^{2} {Q}_{Loop}^{2}}{{k}_{23}^{2} {Q}_{Coil}^{2} + {( 1 + {k}_{lc}^{2} {Q}_{Coil} {Q}_{Loop} )}^{2}} \qquad ( 3 )$$

To derive an expression for k_{Critical}, the maximum of Eq. 3 is found by differentiating with respect to k₂₃. Then k_{Critical} is the point along the k₂₃ axis of FIG. 2a that (for positive values of k and Q) sets this derivative to zero:

$${k}_{Critical} = \frac{1}{{Q}_{Coil}} + {k}_{lc}^{2} {Q}_{Loop} \qquad ( 4 )$$

Finally, k_{Critical} is substituted for k₂₃ in Eq. 3 to find the voltage gain at the critical coupling point: V_{GainCritical}=ik_{Ic}²Q_{Coil}Q_{Loop}/2(1+k_{Ic}²Q_{Coil}Q_{Loop}). Using Eq. 2, and assuming that R_{load}=R_{source}, this voltage gain can be converted into |S₂₁|, which will be convenient to abbreviate G_{Critical}:

$${G}_{Critical} ≡ {\vert {S}_{21} \vert}_{Critical} = \frac{{k}_{lc}^{2} {Q}_{Coil} {Q}_{Loop}}{1 + {k}_{lc}^{2} {Q}_{Coil} {Q}_{Loop}} = \frac{{k}_{lc}^{2} {Q}_{Loop}}{{k}_{Critical}} \qquad ( 5 )$$

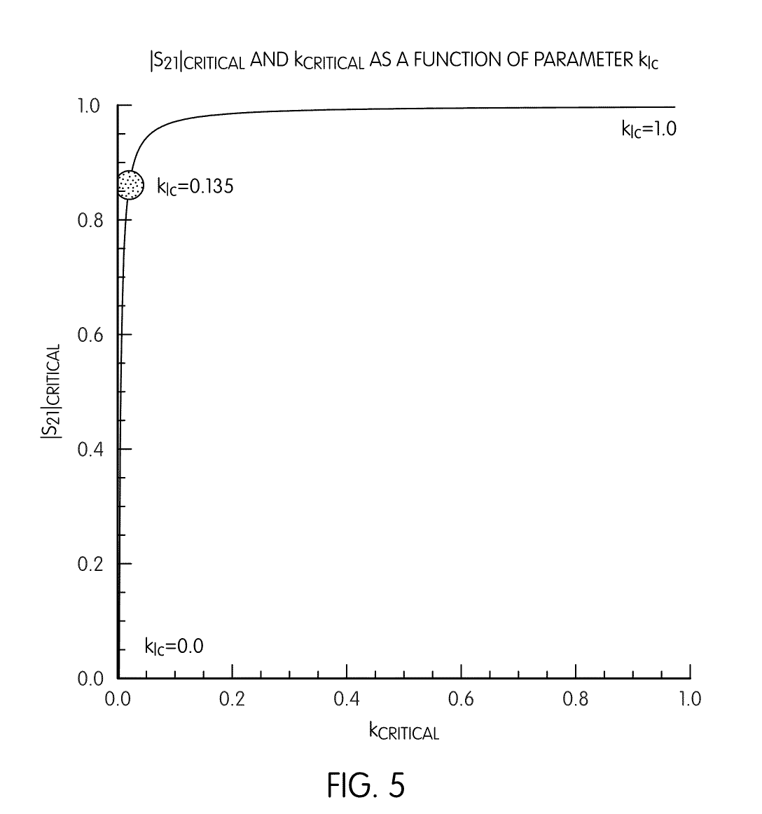

This equation quantifies the system's efficiency at the furthest point on the magic regime ridge. Recall that in order to maximize range, we must minimize k_{Critical} because this increases the extent of the magic regime, which spans from k_{Critical} to 1.0. Examining Eq. 4, reducing k_{Ic} lowers k_{Critical} and therefore increases range. However, according to Eq. 5, reducing k_{Ic} also reduces efficiency. Indeed, the choice of k_{Ic} trades off the efficiency level in the magic regime (height of magic regime ridge) vs. the extent of the magic regime (spatial extent of magic regime, i.e. maximum range). FIG. 5 is a plot of this tradeoff curve, |S₂₁|_{Critical} vs k_{Critical} as a function of the common parameter k_{Ic}.

The area under this tradeoff curve serves as a useful figure of merit (FOM) for system performance: FOM=∫₀¹G_{Critical}dk_{Critical}. An optimal wireless power system, which could losslessly deliver power at infinite range (0 coupling), would have an FOM of unity. For the symmetrical case (in which corresponding parameters on the transmit and receive sides are equal), the FOM integral can be evaluated analytically. Assuming that Q_{Coil}>1, the area under the tradeoff curve turns out to be

$$FOM = 1 - \frac{1}{{Q}_{Coil}} - \frac{ln {Q}_{Coil}}{{Q}_{Coil}} . \qquad ( 6 )$$

The FOM turns out to depend only Q_{Coil}, and is independent of Q_{Loop}. The quality factor of the resonators (coils) entirely determines this measure of system performance, which approaches to unity in the limit of infinite Q_{coil}. The measured Q_{Coil} values for the experimental system, which is discussed further below, are around 300 and 400, corresponding to FOM=0.978 and FOM=0.982 (plugging each Q_{coil} value into the symmetric FOM formula).

Choosing a feasible value of Q_{Loop} is the next important design question. To derive a guideline, an expression is found for the “knee” of the range-efficiency tradeoff curve, which we will define to be the point at which the slope

$$\frac{d {G}_{Critical}}{d {k}_{Critical}}$$

equals unity. The value of k_{Critical} at which this occurs turns out to be

k_{CriticalKnee}=Q_{Coil}^{-1/2} (7)

If Q_{Loop} is too small, then even setting k_{Ic} to its maximum value of 1.0, k_{Critical} will not be able to reach k_{CriticalKnee}. To find the minimum necessary Q_{Loop} value, Eq. 4 can be solved for Q_{Loop} with k_{Critical}=k_{CriticalKnee} and k_{Ic}=1, which yields Q_{Loop}=(Q_{Coil}^{1/2}−1)Q_{Coil}⁻¹≈Q_{Coil}^{-1/2} for large Q_{Coil}. Specifically, a good operating point on the tradeoff curve should be achievable as long as Q_{Loop}>Q_{Coil}^{-1/2}. For Q_{Coil}=300, this condition becomes Q_{Loop}>0.06.

A conclusion is that Q_{Coil} determines system performance (as measured by our FOM), as long as a minimum threshold value of Q_{Loop} is exceeded. The actual value of Q_{Loop} is dominated by the source and load impedances. The larger Q_{Coil} is, the smaller the required minimum Q_{Loop}. Conversely, moving to a more demanding load (with Q_{Loop} below the current threshold value) could be accomplished by sufficiently increasing Q_{Coil}.

Turning now to FIG. 1c which shows an experimental validation of the model. FIG. 1c shows transmitter coils (Tx Coil) and receiver coils (Rx Coil) that was used to validate the theoretical model, and to implement automatic range and orientation tuning. The transmitter on the left includes a small drive loop (Tx Loop) centered within a flat spiral transmit resonator (Tx Coil); the receiver side loop (Rx Loop) and coil (Rx Coil) are visible on the right. The system was characterized with a vector network analyzer in addition to the circuit values shown in Table S1 and S2, below. The first group of measurements consisted of S₁₁ measurements; the S₁₁ scattering parameter is the ratio of complex reflected voltage to complex transmitted voltage at the input port. The ratio of reflected to transmitted power is given by |S₁₁|². L, C, and R values were extracted for each loop by fitting a model with these parameters to the S₁₁ data. The second group of measurements were S₁₁ measurements of the Tx Loop coupled to the Tx Coil, and corresponding measurements on the receiver side. Values were extracted for coil resonant frequency f₀ and Q, as well as loop-coil coupling coefficients k₁₂ and k₃₄, again by fitting a model to data from both groups of measurements. It is not likely to extract L, C, and R values for the coils from these measurements because more than one parameter set is consistent with the data. So, an inductance value was calculated numerically for the coils based on their geometry, which then allowed C and R values to be calculate given the Q and f values.

The distance-dependent coupling coefficients are k₂₃ (the main coil to coil coupling constant), and the parasitic coupling terms k₁₃, k₂₄, and k₁₄. To measure these, vector S₂₁ data (not just |S₂₁|) was collected at a variety of Tx-Rx ranges for the complete 4 element system. Then at each distance, a non-linear fit was performed to extract the coupling coefficients. As an alternative method for finding the coupling coefficients, Neumann's formula was used to calculate the coupling coefficients directly from geometry.

Table S1 shows circuit values used to evaluate the elementary model.

TABLE S1

| PARAMETER | Value | |
|---|---|---|
| R_{source}, R_{Load} | 50 | Ω |
| L₁, L₄ | 1.0 | uH |
| C₁, C₄ | 235 | pF |
| Rₚ₁, Rₚ₄ | 0.25 | Ω |
| K₁₂, K₃₄ | 0.10 | |
| L₂, L₃ | 20.0 | uH |
| C₂, C₃ | 12.6 | pF |
| Rₚ₂, Rₚ₃ | 1.0 | Ω |
| K₂₃ | 0.0001 to 0.30 | |
| ƒ₀ | 10 | MHz |

| | |
|---|---|
| Frequency | 8 MHz to 12 MHz |

It is to be noted that the expression for k_{Critical} (Eq. 4) specifies the value of k₂₃ that would be required to achieve critical coupling; it is not the case that the required coupling is achievable for all choices of Q, since only values corresponding to k₂₃≦1 are realizable. Since all quantities in Eq. 4 are positive, it is clearly necessary (though not sufficient) that 1/Q_{Coil}≦1 and that k_{Ic}²Q_{Loop}≦1 for a realizable k_{Critical} to exist. If a realizable k_{Critical} does not exist, then there is no tuning that will allow the system to achieve the full efficiency of the magic regime; even when the system is maximally coupled, so that k₂₃=1, the system would operate in the sub-optimal under-coupled regime. It is to be noted that in practice it may not be possible to achieve k_{Ic}=1, which would then require a larger minimum value of Q_{Loop}. Also, it is merely a coincidence that the minimum value of Q_{Loop} happens to be numerically so close to the value of k_{CriticalKnee}, since these are logically distinct.

To evaluate the integral of the parametric curve G_{Critical} vs k_{Critical} (both of which are parameterized by k_{Ic}), k_{IcMax} is solved for in Eq. 4, the value of the parameter k_{Ic} corresponding to the upper integration limit k_{Critical}=1.0, finding

$${k}_{lcMax} = \sqrt{\frac{{Q}_{Coil} - 1}{{Q}_{Loop} {Q}_{Coil}}} .$$

The correct lower integration limit is k_{Ic}=0. So,

$$FOM = {\int }_{0}^{{k}_{lcMax}} {G}_{Critical} \frac{d {k}_{Critical}}{d {k}_{lc}} d {k}_{lc} , with \frac{d {k}_{Critical}}{d {k}_{lc}} = 2 {k}_{lc} {Q}_{Loop} .$$

Note that the power vs. range tradeoff does not indicate that power deliverable falls as the receiver moves further from the transmitter; it indicates that choice of k_{Ic} trades off the extent of the “magic regime” (width of the magic regime plateau) with the amount of power delivered within the magic regime (height of the plateau).

The model was experimental validation using a drive loop that was 28 cm in diameter, with a series-connected variable capacitor used to tune the system to about 7.65 MHz. A SubMiniature version A (SMA) connector was also placed in series so that a RF amplifier was able to drive the system as described in FIG. 1a. The large transmitter coil started with an outer diameter of 59 cm and spiraled inwards with a pitch of 1 cm for approximately 6.1 turns. It was difficult to accurately predict the self capacitance of the coils, so the resonant frequency was tuned by manually trimming the end of the spiral until it resonates at ^{˜}7.65 MHz. The receiver was constructed similarly although minor geometrical differences which resulted in the Rx coils having roughly 6.125 turns after being tuned to ^{˜}7.65 MHz. All the elements were made of 2.54 mm diameter copper wire, supported by Plexiglas armatures.

A first group of measurements of the experimental set-up included S₁₁ measurements (where S₁₁ is the ratio of reflected voltage to transmitted voltage at the input port) of the Tx loop (denoted Measurement 1T in Table S2) and Rx loop (Measurement 1R), without the coils. From these, L, C, and R values were extracted for the loops by least squares fitting. The second group of measurements were S₁₁ measurements of the Tx loop coupled to the Tx coil (Measurement 2T), and a corresponding receiver-side measurement denoted 2R. Using data from the second group of measurements and the previously extracted loop parameters, values were extracted for coil resonant frequency f₀ and Q, as well as loop-coil coupling coefficients k₁₂ and k₃₄. It was not possible to extract L, C, and R values from these measurements. So, an inductance value for the coils based on their geometry was calculated numerically, which then allowed C and R values to be calculated.

Table S2 is shown below.

TABLE S2
MEASURED AND CALCULATED STATIC (NON-DISTANCE
DEPENDENT) SYSTEM PARAMETERS

| TRANSMITTER | | | RECEIVER | | |
|---|---|---|---|---|---|
| COMPONENT | VALUE | SOURCE | COMPONENT | VALUE | SOURCE |
| L₁ | 0.965 uH | Measurement 1T | L₄ | 0.967 uH | Measurement 1R |
| C₁ | 449.8 pF | Measurement 1T | C₄ | 448.9 pF | Measurement 1R |
| Rₚ₁ | 0.622 Ω | Measurement 1T | Rₚ₄ | 0.163 Ω | Measurement 1R |
| R_{source} | 50 Ω | Manufacturer | R_{load} | 50 Ω | Manufacturer |
| | | Spec | | | Spec |
| Q₁ | 0.91 | L₁, C₁, Rₚ₁, R_{source} | Q₄ | 0.93 | L₄, C₄, Rₚ₄, R_{load} |
| F₁ | 7.64 MHz | L₁, C₁ | F₄ | 7.64 MHz | L₄, C₄ |
| K₁₂ | 0.1376 | Measurement 2T; | K₃₄ | 0.1343 | Measurement 2R; |
| | | L₁, C₁, Rₚ₁ | | | L₄, C₄, Rₚ₄ |
| Q₂ | 304.3 | Measurement 2T; | Q₃ | 404.4 | Measurement 2R; |
| | | L₁, C₁, Rₚ₁ | | | L₄, C₄, Rₚ₄ |
| Fₒ₂ | 7.66 MHz | Measurement 2T; | Fₒ₃ | 7.62 MHz | Measurement 2R; |
| | | L₁, C₁, Rₚ₁ | | | L₄, C₄, Rₚ₄ |
| L₂ | 39.1 uH | Calculation 1T | L₃ | 36.1 uH | Calculation 1R |
| C₂ | 11.04 pF | L₂, Fₒ₂ | C₃ | 12.10 pF | L₃, Fₒ₃ |
| Rₚ₂ | 6.19 Ω | L₂, Fₒ₂, Q₂ | Rₚ₃ | 4.27 Ω | L₃, Fₒ₃, Q₃ |

The experimental set-up showed that the system was able to perform adaptive frequency tuning for range-independent maximum power transfer. The lower frequency mode had a higher amplitude in the experimental set-up (partly because of the sign of the parasitic signals), so when splitting occurs, the lower mode was automatically selected. From this, the benefit of the frequency tuning is apparent at short range, because the frequency that was chosen for the non-adaptive case (7.65 MHz) was appropriate for the long range situation. However, if a different frequency had been chosen for the fixed case, the benefit could have been apparent at the longer ranges rather than the shorter range.

Note that increasing range and increasing angle mismatch both decrease k₂₃, and the range and orientation mismatch together diminish k₂₃ further; thus if the receiver had been further away, orientation adaptation would not have succeeded over such a wide range of angles. For extreme values of receiver angle, discussed further below, the coupling k₂₃ drops sufficiently that the system is no longer in the over-coupled regime, so there is no splitting and no change in optimal system frequency with coupling constant; thus the fixed and auto-tuning performance coincide.

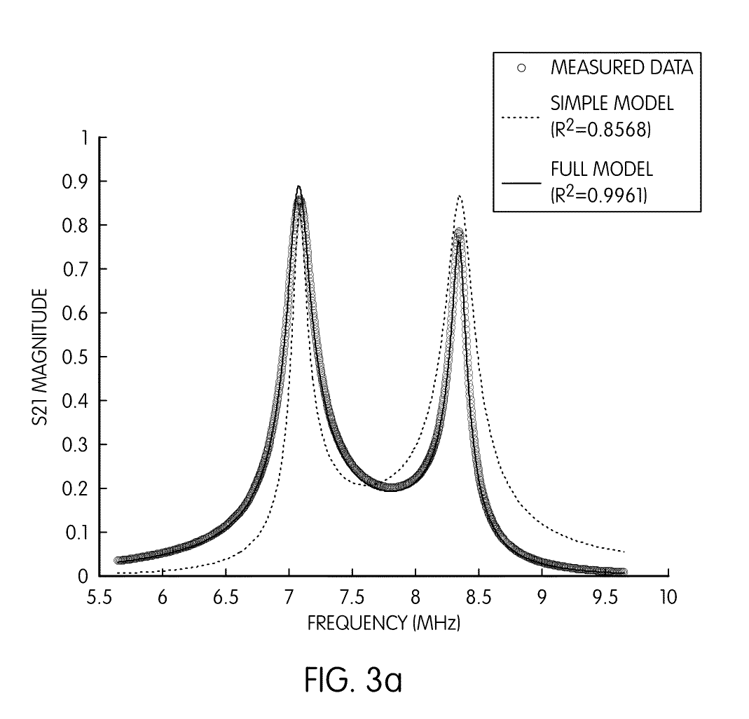

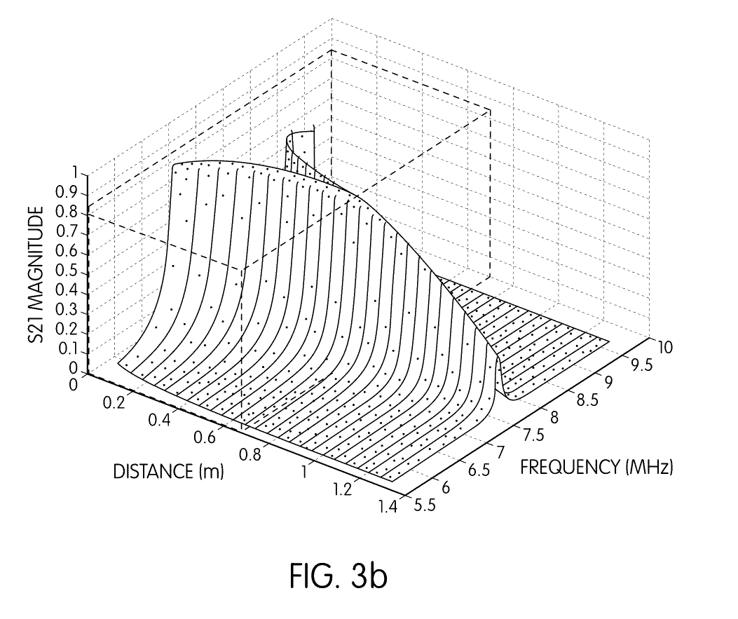

FIG. 3a compares experimentally measured |S₂₁| data to the simple model of Eq. 1, and to a more complete model that includes parasitic couplings. The Figure shows a comparison of experimental data (dots) to the elementary transfer function (dotted line), and to the complete transfer function (line), for the best fit value of k₂₃. The simple model neglects parasitic coupling and does not reproduce the amplitude difference between the upper and lower modes. The complete model reproduces this amplitude difference, which is explained by the phase of the parasitic (e.g. k₁₃) coupling terms relative to the non-parasitic terms (e.g. k₂₃) for the two resonant modes. The agreement between the complete model and the experimental data is excellent. The difference in the magnitude of the |S₂₁| peaks for the upper and lower modes (in FIG. 3a visible in the experimental data and in the complete model, and not present in the elementary model) can be explained by considering the phase of the two modes.

Based on the dynamics of coupled resonators, the lower frequency mode that the current in the transmitter coil is expected to be approximately in phase with the current in the receiver coil; in the higher frequency mode, the coil currents are expected to be approximately anti-phase (180 degrees out of phase).

In the lower mode, in which the Tx coil and Rx coil are in phase, the parasitic feed-through from the drive loop to the Rx coil (associated with coupling constant k₁₃) contributes constructively to the magnitude of the current in the receive coil. In the upper mode, the Rx coil phase is inverted but the parasitic feed through is not, so the feed through interferes destructively with the Rx coil current. Similar arguments apply to the other parasitic couplings. The fact that the mode magnitude differences are modeled well only when parasitic couplings are included (as shown in FIG. 3a) supports this conclusion.

As disclosed above, other impendence-matching components such as discrete matching network or shielded transformer may be used to connect the source/load to the coils, eliminating inductively coupled loops. This would eliminate the cross coupling term and simplify the model, and possibly also simplify system construction. On the other hand, the parasitic feedthrough benefits system performance in the lower mode, and this benefit will be lost by eliminating the loop.

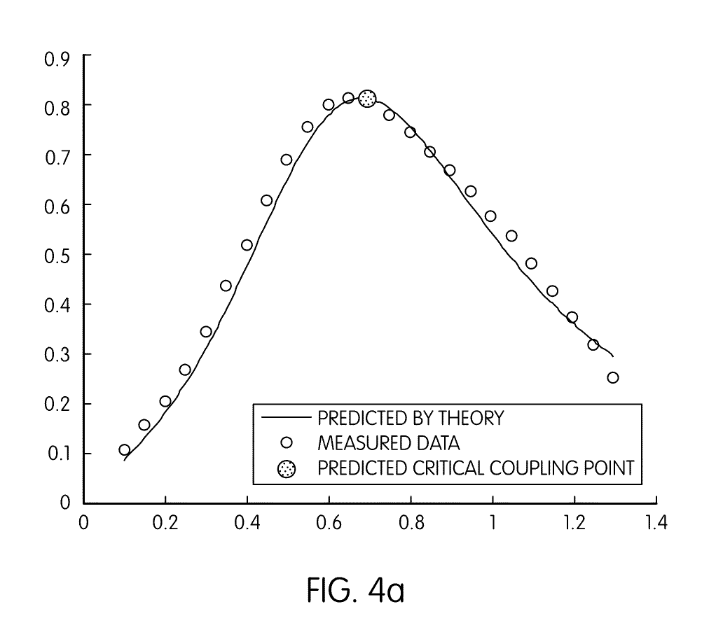

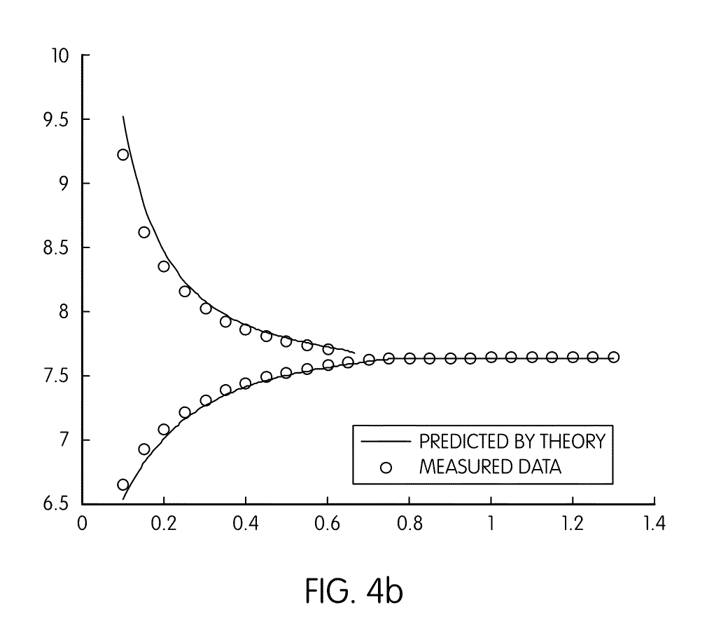

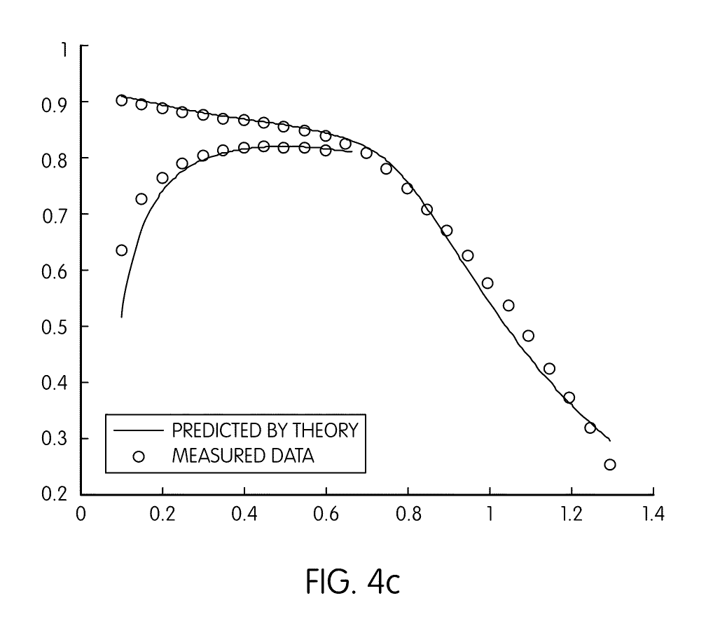

FIG. 3b shows experimental data and the theoretical model, using coupling coefficients extracted separately for each distance. Experimental S21 magnitude data (dots) and analytical model (surface) computed from the complete transfer function, both plotted versus frequency and Tx-Rx distance. Note that each distance slice in the analytical surface is for an independently fit value k₂₃. As discussed above, the dotted box encloses the over-coupled region. For distances between experimental measurements (i.e. between the contours), k₂₃ values were interpolated linearly from neighboring k₂₃ values. Results using k₂₃ computed directly from geometry are presented in the FIGS. 4a, 4b and 4c discussed below.

FIGS. 4a, 4b and 4c compare experimental data to the model, using only calculated coupling coefficients in the model. The model (lines) compared to experimental data (circles), with k₂₃ values calculated from geometry (not fit to data). FIG. 4a shows |S₂₁| vs distance. Predicted maximum coupling point is plotted as a solid dot. FIG. 4b shows resonant peak locations as a function of distance. Frequency splitting is apparent below a critical distance. This plot can be thought of as the ridge lines of FIG. 3b viewed from above. FIG. 4c shows resonant peak magnitudes as a function of distance. This plot can be thought of as the ridge lines of FIG. 3b viewed from the side. In the simple model, these two branches would have the same magnitude; including parasitic couplings accounts for the magnitude difference between the modes.

In FIGS. 4a, 4b and 4c, only the static system parameters were measured; the dynamic (distance-dependent) parameters were calculated. The agreement is generally good, although at close range the numerical calculations become less accurate. This may be because capacitive coupling effects, which were not modeled, become more significant at close range.

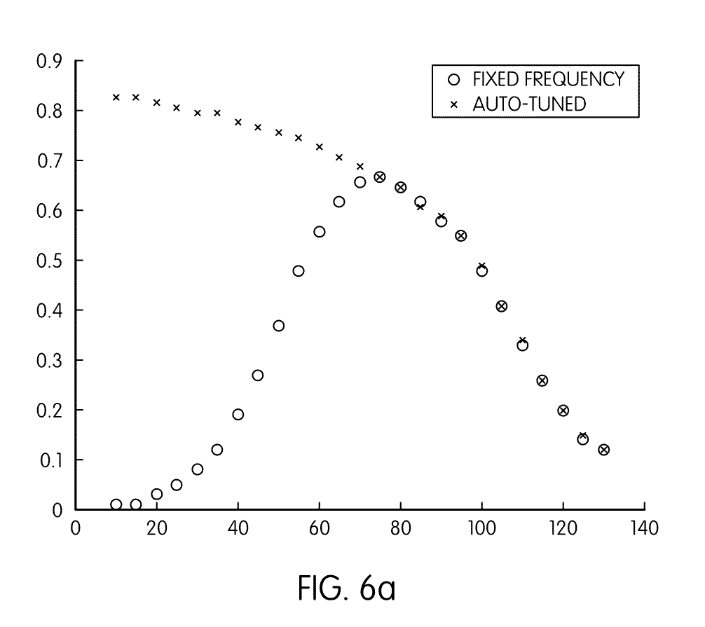

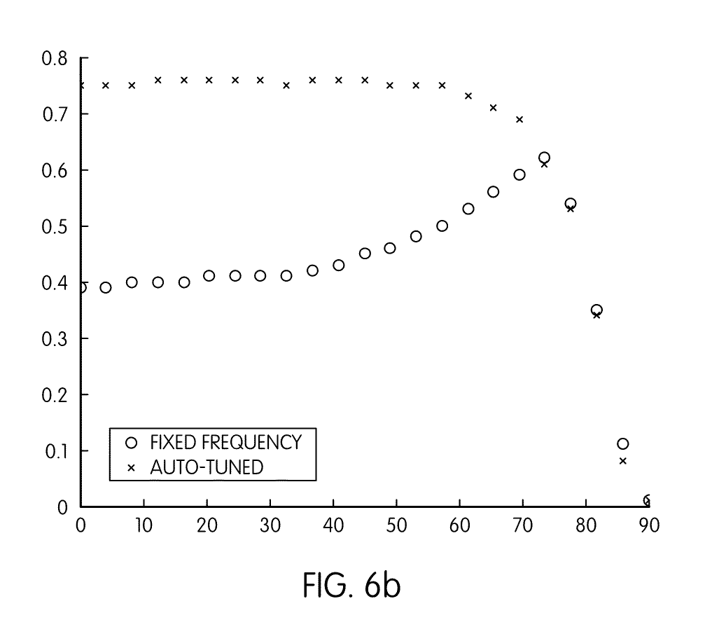

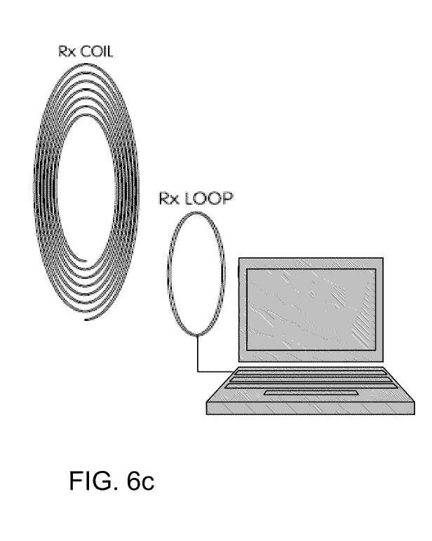

Adaptive frequency tuning may be implemented for range-independent maximum power transfer. When the system is mis-tuned, for example when a non-optimal frequency is chosen, the impedance mis-match causes a reflection at the transmitter side; when the system is optimally tuned, the ratio of reflected to transmitted power is minimized. Thus if the transmitter is capable of measuring S₁₁, and adjusting its frequency, it can choose the optimal frequency for a particular range or receiver orientation by minimizing S₁₁ (that is, minimizing reflected and maximizing transmitted signals). FIGS. 6a and 6b shows experimental data for power transfer efficiency from a non-adaptive (fixed frequency) system compared with efficiency data from a working frequency auto-tuning system.

For each distance, the system swept the transmit frequency from 6 MHz to 8 MHz and then chose the frequency with minimal |S₁₁| to maximize efficiency. At the optimal frequency for each distance, the power delivered into a power meter was measured. The range of tuned values was 6.67 MHz to 7.66 MHz. Analogous results are shown in FIG. 6b for receiver orientation adaptation. The system efficiency is nearly constant over about 70 degrees of receiver orientation. Only in the range from 70 to 90 degrees does the power transfer efficiency fall toward zero. In both cases shown in FIGS. 6a and 6b, the fixed frequency chosen was the single coil resonant frequency (i.e. the undercoupled system frequency), so as the system leaves the overcoupled regime, the auto-tuned frequency coincides with the fixed frequency, and so the efficiencies coincide as well.

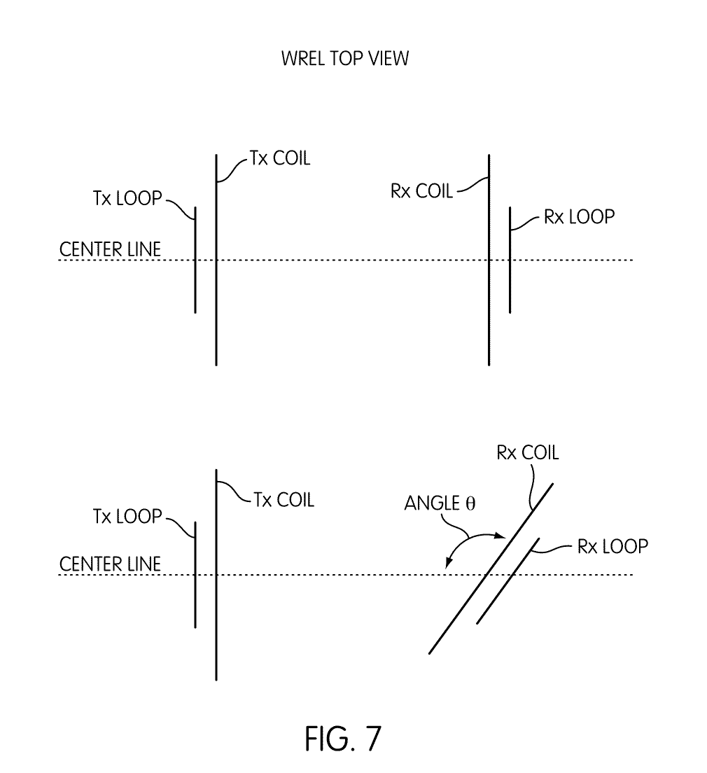

FIG. 7 shows a representative top view of the experimental implementation of FIG. 6a illustrating the varying orientation of the receiver (Rx Coil and Rx Loop) in accordance with various aspects of the present invention. As seen in the top of FIG. 7, Rx Coil and Rx Loop are aligned in orientation with Tx Loop and Tx Coil along a center line. The boom of FIG. 7 shows Rx Coil and Rx Loop rotated through an angle θ with respect to the center line. When the Rx Coil and Rx Loop are arranged as in the top of the Figure, θ=0°. If Rx Coil and Rx Loop were arranged parallel to the center line, then θ=90°.

A tracking scheme that is able to keep the system in tune if the receiver is moved sufficiently slowly and an adaptation techniques for narrowband operation are disclosed. Rather than considering k_{Ic} to be a static design parameter to be optimized (as above), k_{Ic} may be consider as a dynamically variable impedance matching parameter that can enable range adaptation without frequency tuning. If the system is driven at ω₀ (the un-coupled resonant frequency) even though it is actually over-coupled (k₂₃>k_{Critical}), frequency splitting will result in the system being off resonance, and little to no power will be transferred. To bring the efficiency of the system back to a maximum, k_{Ic} can be decreased, causing k_{Critical} in Eq. 4 to decrease, until k₂₃=k_{Critical}, at which point maximum power transfer can resume. The inventors has we have successfully implemented a form of this tuning method in laboratory demonstration systems that allows tuning for a variety of Tx-Rx distances (k₂₃ values) with a hand adjustment of a loop that can be rotated about its coil, changing k_{Ic}. The k_{Ic} adaptation method has the advantage of allowing operation at a single frequency ω₀, which would be advantageous for band-limited operation. Thus, it is of practical interest to develop electronically controllable techniques for k_{Ic} tuning. As noted earlier, the system's loops could be replaced by discrete matching networks; making these matching networks electronically variable could allow automatic k_{Ic} tuning.

By way of a non-limiting example of the tracking and tuning scheme, a value of a loop-to-coil coupling coefficient of the transmitter resonator may be fixed and a frequency may be tune adaptively to choose a desired frequency for a particular value of a transmitter resonator coil-to-receiver resonator coil coupling coefficient. Reflected power may be monitored by the transmitter, for example, and a frequency of the transmitter resonator can be adjusted to minimize the reflected power. In some aspects, the transmitter resonator may sweep through a range of frequencies until the transmitter resonator receives a feedback signal from the receiver resonator. A desired frequency may be determined for a distance between the transmitter resonator and the receiver resonator based on the received feedback signal. The feedback signal may include signals such as a radio signal, WiFi, Bluetooth, Zigbee, RFID-like backscatter, or a load-modulated signal. The load-modulated signal may be modulated on a carrier signal of the transmitter resonator. In some aspects, a desired frequency may be determined for a distance between the transmitter resonator and the receiver resonator based on an impedance matching value between a signal source and a coil of the transmitter resonator.

As discussed above, the coupled resonator wireless power transfer system is capable of adapting to maintain optimum efficiency as range and orientation vary. This is practically important, because in many desirable application scenarios, the range and orientation of the receiver device with respect to the transmit device varies with user behavior. For example, a laptop computer being powered by a coil embedded in the wall of a cubicle would have a different range and orientation each time the user repositioned the device. One feature of the disclosed adaptation scheme is that the error signal for the control system can be measured from the transmitter side only. A separate communication channel to provide feedback from the receiver to the transmitter may not be required.

In some aspects, it is desirable to optimally power smaller size devices, such as hand held devices and scale the power transmitted based on the device size. Powering devices that are smaller than the transmitter is a case of practical interest: consider a computer display or laptop that recharges a mobile phone. The dependence of range on receiver coil size can be discussed by presenting the asymmetric form of Eq. 4, where the critical coupling (where asymmetric means that it is possible that k₁₂≠k₃₄, Q₁≠Q₄, and Q₂≠Q₃):

$${k}_{Critical} = \sqrt{\frac{( 1 + {k}_{12}^{2} {Q}_{1} {Q}_{2} ) ( 1 + {k}_{34}^{2} {Q}_{3} {Q}_{4} )}{{Q}_{2} {Q}_{3}}} \leq 1 \qquad ( 8 )$$

For completeness an asymmetric form of Eq. 5 can be shown to be:

$${\vert {S}_{21} \vert}_{Critical} = \frac{{k}_{12} {k}_{34} {Q}_{1} {Q}_{4} {R}_{Load}}{{k}_{Critical} \sqrt{{L}_{1} {L}_{4}} {ω}_{0}} \qquad ( 9 )$$

Insight into the scaling of range with coil sizes can be gained by starting from an approximate formula for coupling coefficient linking two single-turn coils. Although the coils as tested had five turns, the behavior is expected to be qualitatively similar. The formula assumes that the receive radius is less than the transmit radius (r_{Rx}<r_{Tx}) and that both are on-axis: k(x)≈r_{Tx}²r_{Rx}²(r_{Tx}r_{Rx})^{-1/2}(x²+r_{Tx}²)^{-3/2}. The distance of critical coupling (which measures range) can be solved as:

$${x}_{Critical} = {( ( \frac{{r}_{Tx}}{{k}_{Critical}^{2 / 3}} - {r}_{Rx} ) {r}_{Rx} )}^{1 / 2} \qquad ( 10 )$$

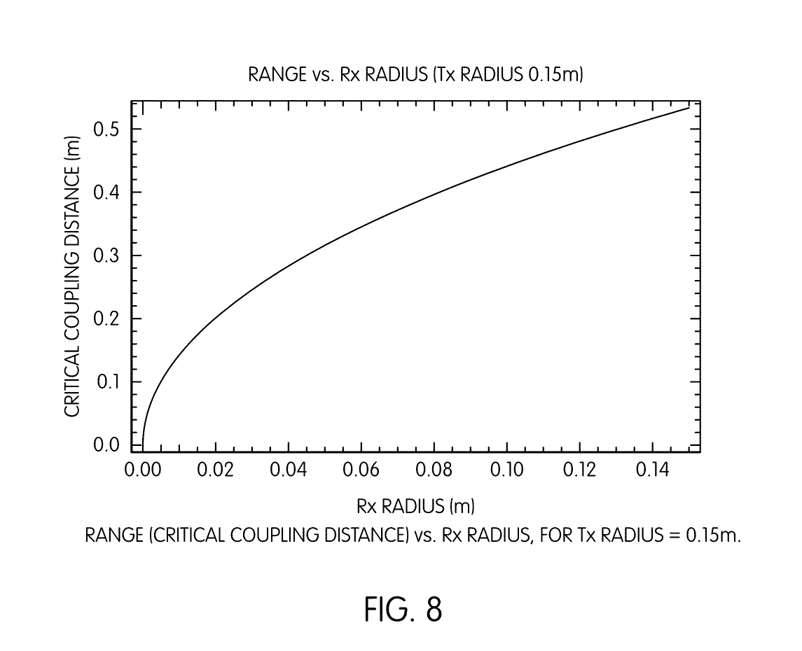

into which the right hand side of Eq. 8 can be substituted. Substituting the measured values from Table S2 above into the right hand side of Eq. 8, substituting the resulting k_{Critical} into Eq. 10, and assuming r_{Tx}=30 cm, plot Eq. 10 is plotted in FIG. 8. According to this plot, it may be possible to power a device of radius 5 cm from a transmitter of radius 15 cm at a range of about 30 cm. This parameter set may support the charging of a cell phone from a wireless power transmitter in a laptop computer.

In some aspects, Tx Coil and/or Rx Coil may be arranged as substantially flat or planar in design. In addition to improving integration with smaller and more planar-sized structure such as a laptop, a flat coil structure can also reduce unwanted spurious radio frequency (RF) emissions, because the substantially flat coil will have a smaller dipole moment in the direction perpendicular to the flat coil.

In some aspects, flat coils may be fabricated by forming a suitable number of turns of magnet wire, solid core wire, stranded wire, Litz wire, hollow copper tubing (producing better weight to conductivity ratio) on a non-conductive substrate or armature that maintains the appropriate flat geometry. Moreover, other methods of manufacturing a multi-turn 2D coil may be used including etched or otherwise patterned conductors and those manufactured by any methods used in printed circuit board fabrication.

Dielectric losses due to the armature materials may be minimized by eliminating all excess material not required for structural stability. The armature may be laser cut from acrylic or plastic, or injection molded from plastic. The substrate may also be glass, plexiglass, Flame Retardant 4 (FR4), silicon, low-loss printed circuit board material, flexible printed circuit board material, polyamide, polycarbonate sold by, for example, Honlex Flexible PCB Industrial Co. Ltd of Taiwan.

In the embodiments herein, the apparatus could be manufactured by semiconductor device fabrication methods such as deposition, removal, patterning, and modification of electrical properties. Deposition methods, for example, include physical vapor deposition (PVD), chemical vapor deposition (CVD), electrochemical deposition (ECD), molecular beam epitaxy (MBE) and, atomic layer deposition (ALD) among others. Removal methods, for example, include wet etching, dry etching, chemical-mechanical planarization (CMP) among others. Patterning methods, for example, include lithography among others. Modification methods, for example, include reduction of dielectric constant via exposure to ultraviolet light in UV processing (UVP) among others.

Substantially flat coils for wireless power transfer may be fabricated by standard printed circuit board (PCB) fabrication methods: traces can be designed in standard CAD programs such as Altium Designer. Wider traces and thicker copper produce higher conductivity values, which provides for better resonator quality factor (Q), which in turn is a determinant of system range and efficiency. The resonator frequency is given by f=1/(2π(LC)^{1/2}); the resonator quality factor is given by (1/R)(L/C)^{1/2}. More turns provides additional inductance, which improves Q if C can be decreased to keep the desired resonant frequency f constant. At some point, the capacitance C can be decreased no further however, limiting the maximum inductance value that can be used for a particular resonant frequency f. An additional factor limiting the number of turns is that increased trace length increases resistance, which decreases Q. The need to increase L by using more turns limits the width of the traces. Balancing these factors has led the inventors to a design with around 6 turns, for operating frequencies in the range 5 MHz to 15 MHz.

Coils for wireless power transfer may also be fabricated using flexible printed circuit board (PCB) methods. Because the flexible PCB substrates are thinner than conventional circuit boards, they may be expected to cause less dielectric loss. PCB substrates made from low dielectric loss materials such as that from Rogers corporation may also be used to reduce dielectric losses. In a micro-electrical-mechanical systems (MEMS) process such as lithography, electroforming and molding (LIGA), thick (high aspect ratio) metal coils (which may be expected to have higher conductivity) may be fabricated on a silicon substrate.

The flat coils may also be fabricated by die stamping sheet metal; cutting metal foil using a vinyl cutter or similar tool; patterning metal using a waterjet, laser cutter, or saw. Flat coils may be fabricated from transparent conductors such as Indium Tin Oxide (ITO) or other Transparent Conductive Material.

Flat coils on the interior of a laptop lid may be patterned by screen printing, silk screening, stenciling, inkjet printing, or other processes capable of printing conductive materials.

The performance of the coils fabricated by several of the methods above can be improved by plating the materials with a higher conductivity, non-oxidizing materials such as silver, gold, or platinum. The coil performance can also be improved by increasing the amount or thickness of conductive material by electroplating or electroless plating (even if the plated material is not particularly high conductivity). The flat coils may be designed to receive power from outside the laptop, and shield emissions from inside. The outline of the 2-D coil is not limited to a specific shape and can adapt to mobile device design considerations, such as circular, rectangular, square or any other arbitrary shape in outline.

According to various aspects of invention, both power and audio may be delivered wirelessly to a receiver/radio receiver/speaker, thereby eliminating the need for a power supply connection to the receiver/speaker. The coupled magnetic resonator system described herein enables efficient power transfer of appreciable power (watts and greater) over moderate distances (^{˜}meters), greatly increasing the range of possible source-to-receiver distances and orientations. As such, the receiver/speaker may be moved through a range of distances and orientations relative to the transmitter.

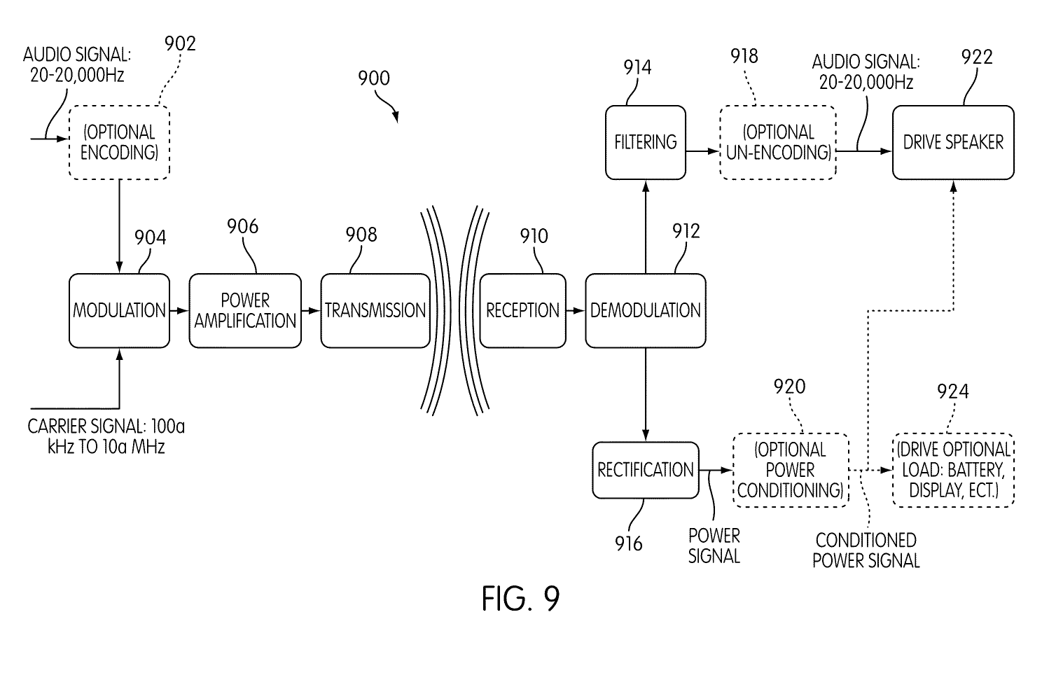

FIG. 9 shows an exemplary functional block diagram 900 for wirelessly powering a speaker in accordance with various aspects of the present disclosure. It should be understood that the arrangement of various functional blocks depicted in FIG. 9 is exemplary and other arrangements may be used without departing from the scope of the disclosure. Various operations performed are depicted by the functional blocks in FIG. 9 and signals are shown as lines. In some implementations, various operations may be performed in different sequences. In other implementations, additional operations may be performed along with some or all of the operations shown in FIG. 9. In yet other implementations, one or more operations may be performed simultaneously. In yet other implementations, one or more of operations may not be performed. Accordingly, the operations described are exemplary in nature and, as such, should not be viewed as limiting.

An audio signal (^{˜}20-20,000 Hz) may be used to modulate a power carrier signal which may be in the range inclusive of 100-999 kHz to 10-99 MHz (significantly higher frequency than the audio signal). A modulation operation 904 may be performed to modulate the power carrier signal with the audio signal to form a modulated signal. The modulated signal may be a single waveform that delivers both power and audio signals. In some implementations, an optional encoding operation 902 may be performed to encode the audio signal prior to the modulation operation 904. A power amplification operation 906 may be performed to amplify the modulated signal and transmission operation 908 may be performed to transmit the amplified modulated signal.

A reception operation 910 may be performed to receive the transmitted signal. A demodulation operation 912 may be performed to demodulate the received signal including the modulated signal. The demodulation operation 912 may be performed to demodulate the modulated signal to output a power signal, an audio signal or both. In some implementations, a filtering operation 914 may be performed on the demodulated signal and the resulting audio signal may be delivered to a receiver/speaker/audio output and may carry sufficient power to drive the speaker in operation 922. In cases where the optional encoding operation 902 was performed, demodulation operation 912 may be performed to demodulate the modulated signal to output a power signal, an encoded audio signal, or both. An optional decoding operation 918 may be performed to decode the filtered signal including, for example, a filtered encoded audio signal prior to being delivered to the receiver/speaker/audio output.

In some implementations, a rectification operation 916 and/or power conditioning operation 920 may be performed on the demodulated signal to produce a DC power signal. In case an optional power conditioning operation 920 is performed, a conditioned DC power signal may be output. The power signal may deliver power to a load/electronics that may or may not be directly related to the speaker function. For example, the power signal may be used to, among other things, power a speaker amplifier, power a display (or other visual indicator, e.g., light) associated with the receiver, power a user input device associated with the receiver, power control circuitry (for battery charging, speaker operation, display, inputs, etc.) associated with the receiver, power an independent wireless communication system (for example, where audio and/or control data may be communicated between speaker and amplifier, among multiple speakers, etc.), and/or power other electronics.

In some implementations, appropriate operations may be performed during the demodulation operation and/or after the demodulation operation to output audio and/or power signals having various different power levels. For example, in some implementations, a high power audio signal may be output which may be used to drive the speaker. The high power audio signal may be referred to as a speaker level audio signal that may have sufficient power to directly drive a low impedance input, for example, an 8 Ohm speaker. In this case, no power signal may be output or a power signal with low power may be output. The weak power signal may or may not have sufficient power to power some electronics associated with the receiver. In some implementations, the power levels of the audio signal and the power signal may be substantially the same, wherein the audio signal may still be a speaker level audio signal having sufficient power to drive the speaker and the power signal may be used to power various electronics. In some implementations, a low power audio signal may be output which may not have sufficient power to drive the speaker. The low power audio signal may be referred to as a line level audio signal that may be an audio only signal (without significant current or power), capable of driving a high impedance input, for example, amplifier input. An audio amplification (for example, by a speaker amplification circuit) operation (not shown) may be performed to amplify the low power audio signal prior to being delivered the receiver/speaker/audio output 922. In this case, the power signal output may be high power signal which may drive the speaker, power the speaker amplification circuit, and/or power other electronics.

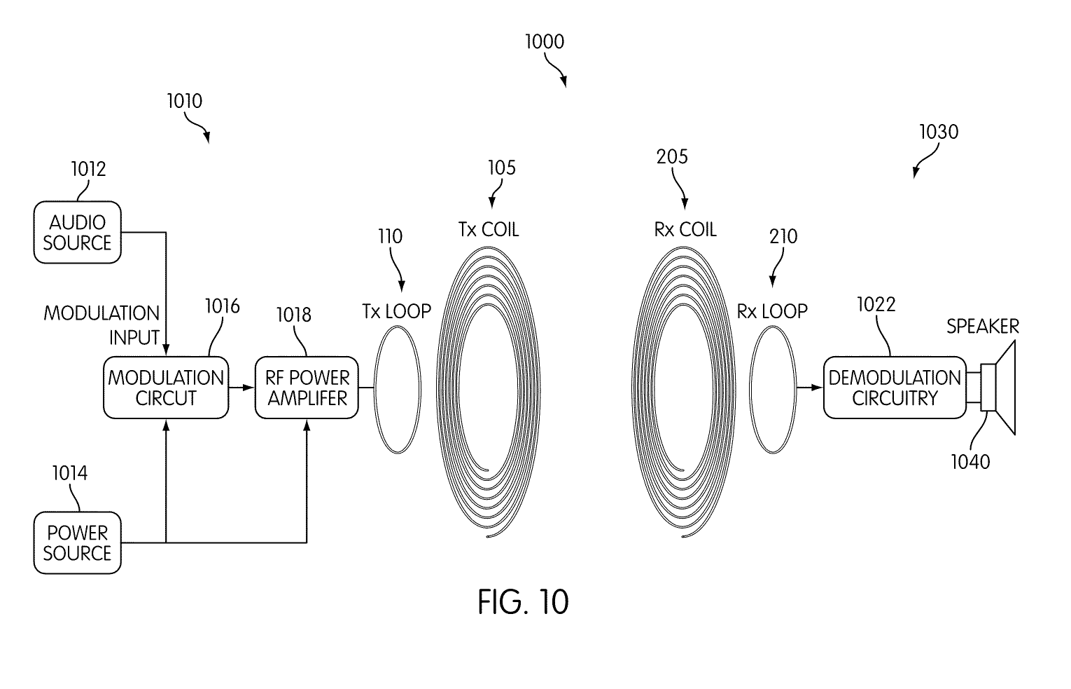

FIG. 10 shows an exemplary implementation of a system 1000 for wirelessly powering a speaker in accordance with various aspects of the present disclosure. Transmitter 1010 may be configured to supply power and audio signals wirelessly to receiver 1030. Transmitter 1010 includes a transmitter resonator or resonator of transmitter 105 as a coil (Tx Coil). Similarly, receiver 1030 includes a receiver resonator or resonator of receiver 205 as a coil (Rx Coil). The transmitter resonator (Tx Coil) may be coupled to a transmitter impedance-matching structure 110. Similarly, receiver resonator (Rx Coil) may be coupled to a receiver impedance-matching structure 210. As shown in FIG. 10, the transmitter impedance-matching structure 110 may be a loop (Tx Loop) and the receiver impedance-matching structure 210 may be a loop (Rx Loop). Impedance-matching structure 110 may be configured to match an impedance of power amplifier 1018 and an impedance of transmitter resonator 105. Impedance-matching structure 210 may be configured to match an impedance of demodulation circuit 1022 and an impedance of receiver resonator 205. One of ordinary skill in the art would recognize that impedance-matching structure 110 may be configured to match an impedance of transmitter resonator 105 to a final stage of modulation circuit 1016 and/or power amplifier 1018. Also, impedance-matching structure 210 may be configured to match an impedance of receiver resonator 205 to a first stage of demodulation circuit 1022. Other impedance-matching structures may be used for the transmitter 1010, the receiver 1030, or both which may include a transformer and/or an impedance-matching network. The impedance matching network of the transmitter may include inductors and capacitors configured to connect power amplifier 1018 to the transmitter resonator 105. The impedance matching network of the receiver may include inductors and capacitors configured to connect demodulation circuit 1022 to the receiver resonator 205.

Transmitter 1010 may include modulation circuit 1016, power amplifier 1018, and/or other components. Audio source 1012 may provide an audio signal as modulation input to modulation circuit 1016. Modulation circuit 1016 may also receive a power carrier signal as input and may modulate the power carrier signal with the audio signal to form a modulated signal. The carrier frequency of the power carrier signal may be fixed or user-selectable. In some implementations, modulation circuit 1016 may include a function generator. The function generator may generate the power carrier signal and may modulate the power carrier signal with the audio signal to form the modulated signal. The modulated signal may be amplified by power amplifier 1018 to form an amplified modulated signal. Power amplifier 1018 may comprise an RF power amplifier. Power from power source 1014 (wired, battery, other sources) may be supplied to audio source 1012, modulation circuit 1016 and/or power amplifier 1018. In some implementations, transmitter 1010 may further include encoding circuitry, and/or other components to perform the encoding operation described above. In some implementations, the power carrier signal may be amplified prior to being modulated with the (encoded or un-encoded) audio signal.

Output (i.e., the amplified modulated signal) from power amplifier 1018 may be fed to the Tx Loop 110 and may be transferred magnetically from Tx Loop to Tx Coil to Rx Coil to Rx Loop. Receiver 1030 may include a demodulation circuit 1022, speaker/speaker element 1040, and/or other components. The received signal including the modulated signal may be demodulated by demodulation circuit 1022. Demodulation circuit 1022 may demodulate the modulated signal to output a power signal, an audio signal or both. The resulting audio signal may be delivered to speaker 1040 and may carry sufficient power to drive the speaker. The audio signal may drive the speaker element directly. Increasing the amplitude (i.e. power) of the audio signal may increase the speaker volume. In some implementations, receiver 1030 may further include filtering circuitry, decoding circuitry, rectification circuitry, power conditioning circuitry, and/or other components to perform the filtering, decoding, rectification, and power conditioning operations described above.

It should be understood that the implementation described in FIG. 10 is exemplary and does not limit the scope of disclosure and/or functions/operations described above. For example, in some implementations, the system may utilize self-contained modulation and amplifier circuits, rather than off-the-shelf function generators and amplifiers.

According to some implementations, the power signal may be sent on a separate channel from the audio signal or data. In other words, the audio signal and power signal may be sent on completely separate bands. The audio signal may be encoded using any of various protocols on various bands. For example, for AM or FM on standard broadcast radio bands, the audio signal may be modulated and demodulated using standard radio methods. The power may be coupled completely separately using the magnetically coupled resonator system described herein. The audio signal may be sent via wireless communication signals (e.g., radio, WiFi, Bluetooth, and/or other signals).

In some implementations, control data may be modulated on the power carrier signal in addition to the audio signal or instead. The control data may include commands to power receiving devices that would affect how much power they consume, power channel sharing commands, association commands, access control commands, and/or other commands.

By wirelessly transmitting power and/or audio, using the coupled magnetic resonator system described herein, the need for a power supply connection to the receiver/speaker may be eliminated; the need for batteries in the receiver/speaker may be eliminated which eliminates the hassle of changing batteries, eliminates battery waste, and reduces speaker weight and volume; the need for amplifier circuitry at the receiver/speaker may be eliminated which may enable smaller speaker packaging; and/or the need for recharging connectors in existing wireless (battery operated) speakers may be eliminated. Cable clutter may also be minimized. Speaker installation and placement may also be facilitated.

Although the above disclosure discusses what is currently considered to be a variety of useful embodiments, it is to be understood that such detail is solely for that purpose, and that the appended claims are not limited to the disclosed embodiments, but, on the contrary, is intended to cover modifications and equivalent arrangements that are within the spirit and scope of the appended claims.

What is claimed is:

1. A transmitter comprising:
a modulation circuit configured to modulate a power carrier signal with an audio signal to form a modulated signal; and
a resonator configured to couple with a resonator of a receiver, wherein the resonator is configured to transmit the modulated signal wirelessly to the resonator of the receiver.

2. The transmitter of claim 1, further comprising:
a power amplifier configured to amplify the modulated signal to form an amplified modulated signal, wherein the resonator is configured to transmit the amplified modulated signal wirelessly to the resonator of the receiver.

3. The transmitter of claim 2, further comprising:
an impedance-matching structure operably connected to the resonator, wherein the impedance-matching structure is configured to match an impedance of the power amplifier and an impedance of the resonator.

4. The transmitter of claim 1, further comprising:
an impedance-matching structure operably connected to the resonator, wherein the impedance-matching structure is configured to match an impedance of the modulation circuit and an impedance of the resonator.

5. A receiver comprising:
a resonator configured to:
couple with a resonator of a transmitter; and
receive a modulated signal wirelessly from the transmitter, wherein the modulated signal comprises a power carrier signal modulated with an audio signal.

6. The receiver of claim 5, further comprising:
a demodulation circuit configured to demodulate the modulated signal to output an audio signal, a power signal, or both.

7. The receiver of claim 5, further comprising:
an impedance-matching structure operably connected to the resonator, wherein the impedance-matching structure is configured to match an impedance of demodulation circuit and an impedance of the resonator.

8. The receiver of claim 6, wherein the audio signal comprises a speaker level audio signal, and wherein the speaker level audio signal is delivered to a speaker associated with the receiver.

9. The receiver of claim 6, wherein the power signal powers one or more of the following:
a speaker amplifier, a display associated with the receiver, a user input device associated with the receiver, a power control circuitry associated with the receiver, a battery charging circuit, and an independent wireless communication system.

10. A method comprising:
coupling a resonator of a transmitter and a resonator of a receiver;
modulating a power carrier signal with an audio signal to form a modulated signal; and
transmitting the modulated signal wirelessly from the resonator of the transmitter to the resonator of the receiver.

11. The method of claim 10, further comprising:
amplifying the modulated signal to form an amplified modulated signal; and
transmitting the amplified modulated signal wirelessly from the resonator of the transmitter to the resonator of the receiver.

12. The method of claim 10, further comprising:
encoding the audio signal to form an encoded audio signal; and
modulating the power carrier signal with the encoded audio signal.

13. A method comprising:
coupling a resonator of a receiver and a resonator of a transmitter; and
receiving a modulated signal wirelessly from the transmitter, wherein the modulated signal comprises a power carrier signal modulated with an audio signal.

14. The method of claim 13, further comprising:
demodulating the modulated signal to output an audio signal, a power signal, or both.

15. The method of claim 14, wherein the audio signal comprises a speaker level audio signal, and wherein the speaker level audio signal is delivered to a speaker associated with the receiver.

16. The method of claim 14, wherein the power signal powers one or more of the following: a speaker amplifier, a display associated with the receiver, a user input device associated with the receiver, a power control circuitry associated with the receiver, a battery charging circuit, and an independent wireless communication system.

17. The method of claim 13, wherein the modulated signal comprises the power carrier signal modulated with an encoded audio signal.

18. The method of claim 17, further comprising:
demodulating the modulated signal to output an encoded audio signal, a power signal, or both.

19. The method of claim 18, further comprising:
decoding the encoded audio signal to form a decoded audio signal.

20. The method of claim 19, wherein the decoded audio signal comprises a speaker level audio signal, and wherein the speaker level audio signal is delivered to a speaker associated with the receiver.
